(19) United States
(12) Patent Application Publication
(10) Pub. No.: US 2025/0266903 A1
(43) Pub. Date: Aug. 21, 2025

(54) METHODS AND SIGNALING FOR MULTIPLE ACCESS FOR AMBIENT IoT

(71) Applicant: APPLE INC., Cupertino, CA (US)

(72) Inventors: Ankit Bhamri, Bad Nauheim (DE); Wei Zeng, San Diego, CA (US); Chunxuan Ye, San Diego, CA (US); Haitong Sun, Cupertino, CA (US); Sigen Ye, San Diego, CA (US); Huaning Niu, San Jose, CA (US); Hong He, San Jose, CA (US); Dawei Zhang, Saratoga, CA (US); Chunhai Yao, Beijing (CN)

(21) Appl. No.: 19/045,775

(22) Filed: Feb. 5, 2025

Related U.S. Application Data
(60) Provisional application No. 63/553,812, filed on Feb. 15, 2024.

(51) Int. Cl. H04B 7/22; G16Y 30/00

(52) U.S. Cl. CPC H04B 7/22; G16Y 30/00

(57) ABSTRACT

Embodiments herein include systems, methods and apparatuses for multi-tone based multiple access for supporting multiple access for ambient internet of things (IoT) devices. Methods and corresponding signaling procedures can allow multiple users to simultaneously transmit and backscatter on different tones within a symbol duration. The network may configure an ambient IoT device to receive and/or transmit/backscatter selectively on multiple tones/chips/frequency shift/resources.

### TECHNICAL FIELD

This application relates generally to wireless communication systems, including ambient IoT devices.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example of multi-tone based multiple access for various ambient IoT devices in accordance with one or more embodiments of the present disclosure.

FIG. 2 illustrates an example where two devices are configured to transmit/backscatter on four tones/chips/frequency shift/resources with a gap that divides the four tones/chips/frequency shift/resources in accordance with some embodiments.

FIG. 3 illustrates an example where for devices are configured to transmit/backscatter with non-contiguous tones/chips/frequency shift/resources in accordance with some embodiments.

FIG. 4 shows an example of tone hopping for multiple access in accordance with one or more examples of the present disclosure.

FIG. 5A illustrates an example embodiment where B_{tx,D2R} and B_{occ,D2R} for 2SB transmission of Manchester line code with option 1, and if no D2R line code is used in accordance with some embodiments.

FIG. 5B illustrates an example embodiment where B_{tx,D2R} and B_{occ,D2R} for 2SB transmission of Manchester line code with option 2, and by Miller line code is used in accordance with some embodiments.

FIG. 5C illustrates an example embodiment where B_{tx,D2R} and B_{occ,D2R} for 1SB transmission of Manchester line code with option 1, and if no D2R line code is used in accordance with some embodiments.

FIG. 6 illustrates a method for an ambient IoT device, according to embodiments herein.

FIG. 7 illustrates a method for a base station, according to embodiments herein.

FIG. 8 illustrates an example architecture of a wireless communication system, according to embodiments disclosed herein.

FIG. 9 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Additionally, embodiments herein are described with regard to Internet of Things (IoT) devices. Reference to an IoT device is merely provided for illustrative purposes, and the embodiment herein may be utilized with any device that have the capability to collect and exchange data. IoT devices may be embedded with sensors, software, and network connectivity, allowing them to communicate with other devices and systems. IoT devices can vary in size, complexity, and functionality. They can range from small, simple devices such as temperature sensors and smart home appliances to more complex devices like industrial machinery and autonomous vehicles.

Some IoT devices include ambient IoT devices. An ambient IoT device is a device that is able to harvest energy from ambient sources. For example, some ambient IoT devices may use radio frequency (RF) waves for power. To power such devices using RF, embodiments herein provide enhancements to a wireless communication system framework to introduce a new category of device(s) that is able to harvest energy from ambient sources. An ambient IoT device may be referred to as an RF powered device. An ambient IoT device may also be a UE device.

There may be multiple types of ambient IoT devices that the wireless communication system may support. For instance, in terms of energy storage, some devices may be battery-less devices with no energy storage capability at all, and completely dependent on the availability of an external source of energy. Some devices may include limited energy storage capability that do not need to be replaced or recharged manually, but can be charged by harvesting energy from ambient sources. In some embodiments, device categorization may be based on characteristics corresponding to a device (e.g., energy source, energy storage capability, passive/active transmission, etc.).

Embodiments herein consider the following set of ambient IoT devices. A first device type, (Device 1) may operate with around one microwatt (μW) peak power consumption, have energy storage, have an initial sampling frequency offset (SFO) up to 10× parts per million (ppm) (e.g., 10⁵ ppm), and provide neither downlink (DL) nor uplink (UL) amplification. The first device type's UL transmission is backscattered on a carrier wave provided externally. For instance, a device may not generate its own active transmission, and reflect or backscatter an incoming signal (carrier wave).

A second device type (Device 2a) may operate with up with a peak power consumption of up to a few hundred μW, have energy storage, have an initial SFO up to 10× ppm, and provide both DL and/or UL amplification in the second device. The second device type's UL transmission is backscattered on a carrier wave provided externally.

A third device type (Device 2b) may operate with up with a peak power consumption of up to a few hundred μW, have energy storage, have an initial SFO up to 10× ppm, and provide both DL and/or UL amplification in the third device. The third device type's UL transmission may be generated internally by the device.

Note that downlink in ambient IOT may be referred to as reader to device (R2D) and the channel for the R2D may be refed to as physical reader to device channel (PRDCH). Uplink in ambient IOT may be referred to as device to reader (D2R) and the channel for the D2R may be refed to as physical device to reader channel (PDRCH).

Dense deployments of ambient IoT devices pose significant challenges in resource scheduling and capacity management due to their high volume and constrained nature. Additionally, the diversity in device capabilities creates additional complications. Multiple access schemes for ambient IoT can be considered to support a device density of up to 100 devices per 100 square meter area. Time-division multiplexing (TDM) based multiple access is simple and straightforward to schedule resources for multiple ambient IoT devices.

However, considering the desire to support such a large number of devices, it may be challenging to simply rely only on TDM based multiple access. This can reduce capacity, latency, and overall user-experienced data rate. In this disclosure, some embodiments provide multi-tone based multiple access for supporting multiple access for ambient IoT devices. The following disclosure proposes methods and corresponding signaling procedure to allow multiple users to simultaneously transmit/backscatter on different tones/chips/frequency shift/resources within a symbol duration. A tone, chip, and frequency resource may refer to different ways in which a symbol may be subdivided to allow multiple ambient IoT devices to use a same symbol. A tone duration herein may refer to a specific tone, at a specific time during a symbol, on a specific frequency shift. The combination of a specific tone, chip, frequency element during a symbol may be referred to as a transmission element within a symbol.

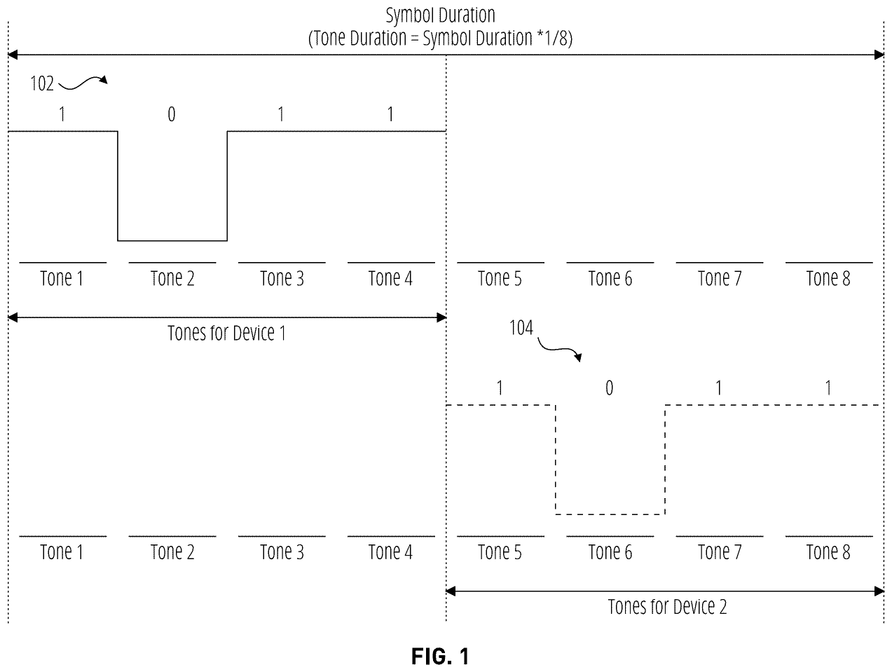

FIG. 1 shows an example of multi-tone based multiple access for various ambient IoT devices in accordance with one or more embodiments of the present disclosure. According to at least one embodiment, a network may configure an ambient IoT device to receive and/or transmit/backscatter selectively on multiple tones/chips/frequency shift/resources, wherein the multiple tones/chips/frequency shift/resources may be generated by sampling at a higher rate corresponding to the symbol rate. For example, an ambient IoT device may be configured by a base station or reader transmit or backscatter a signal on certain tones or frequency shift/resources during certain chips (e.g., a duration of time during a symbol).

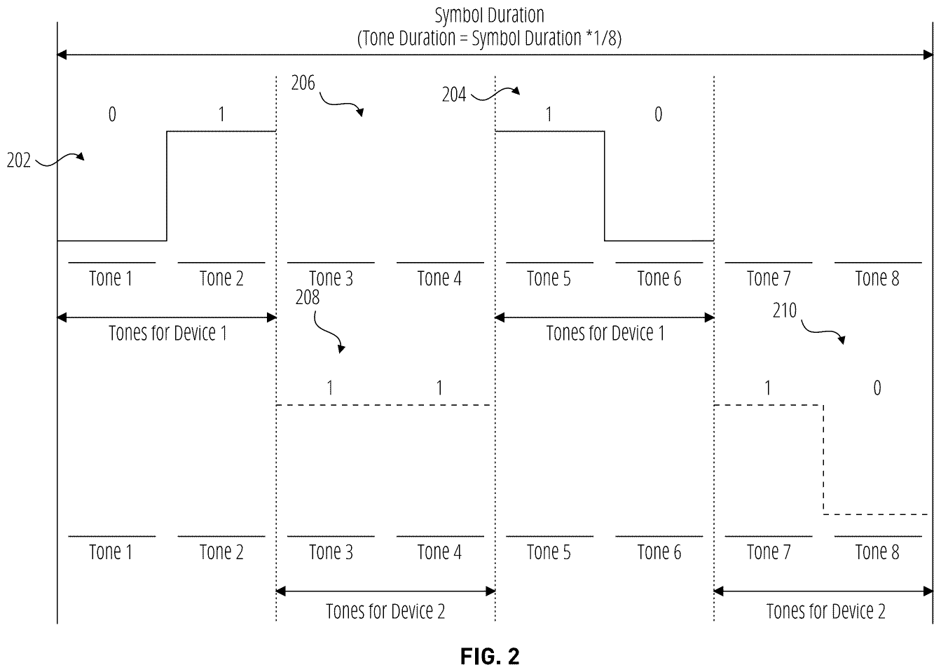

FIG. 2 illustrates a graph in which a tone is used to specify the use of a specific frequency shift or tone during a specific duration (e.g., a chip) of the symbol. Accordingly, the tones shown in FIG. 2 refers to both a frequency shift and a specific time duration within a symbol. For example, an ambient IoT device may be configured to receive an incoming transmission at 15 kHz frequency, and backscatter/transmit a signal by applying a frequency shift and backscattering/transmitting during a specific duration in the time domain.

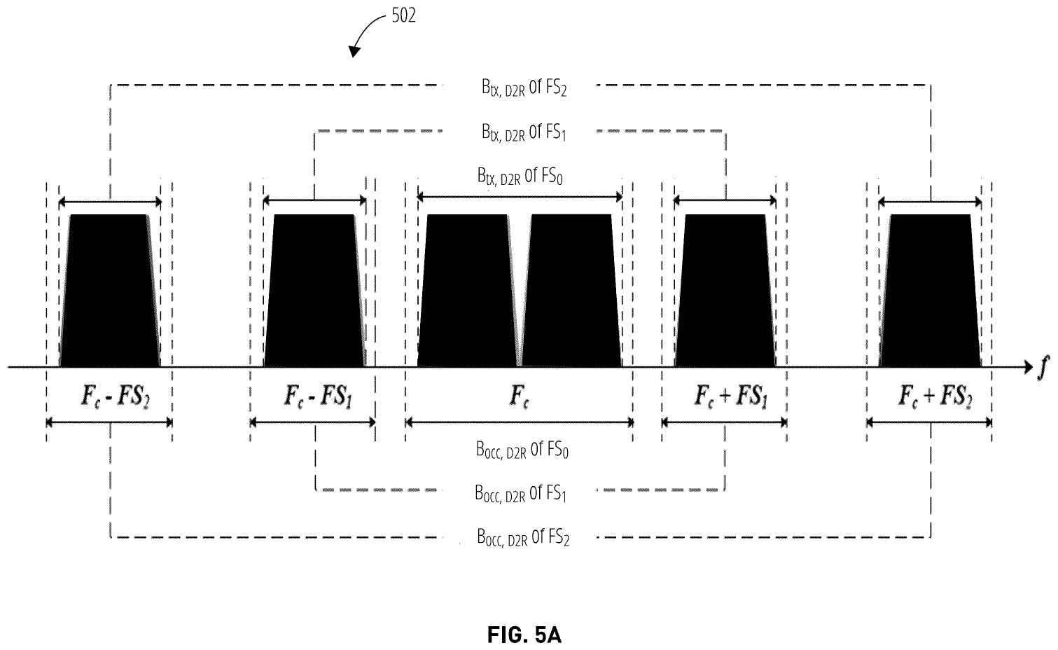

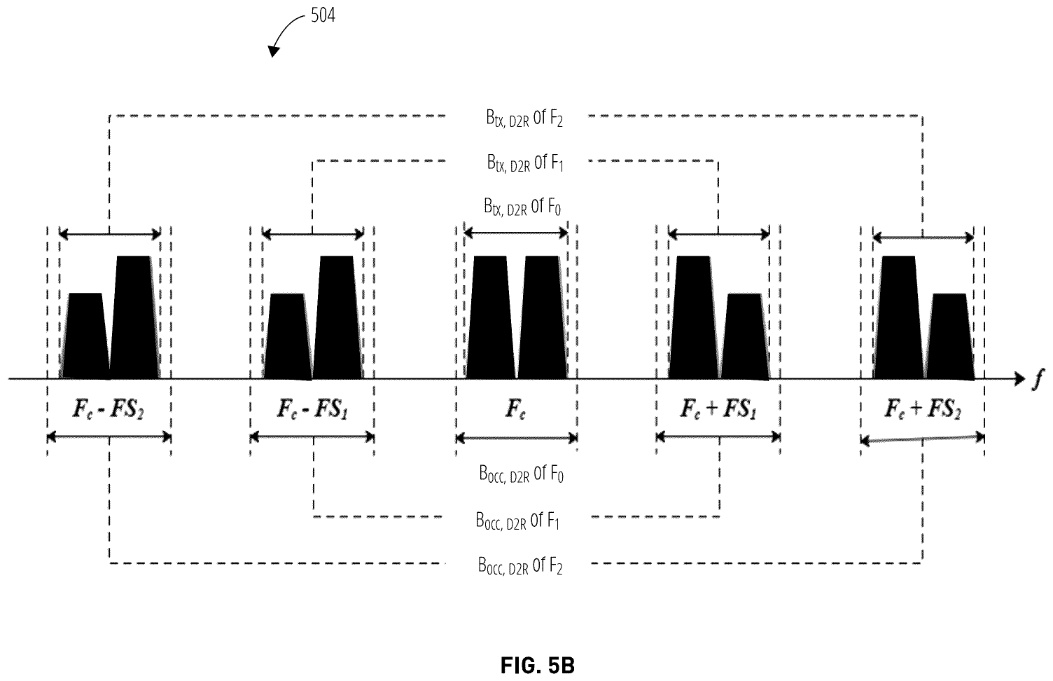

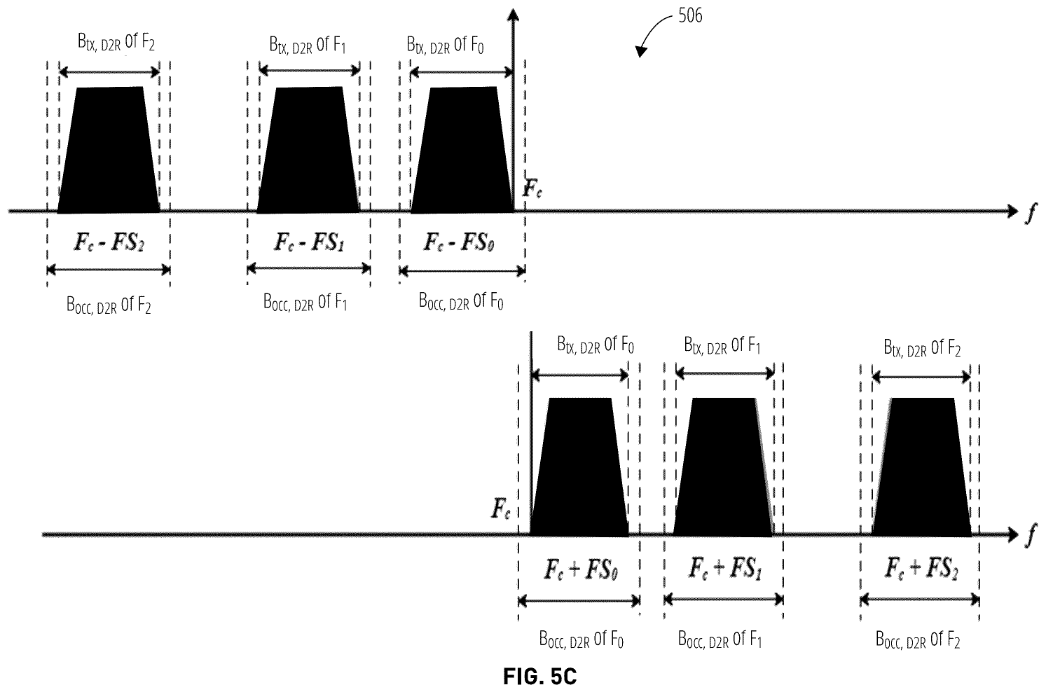

In other words, the entire symbol occupies a certain bandwidth. The symbol is subdivided into a number of chips, and the ambient IoT device may use a configured frequency shift for the chips within the symbol (e.g., a frequency shift that occupies a narrower portion of the transmission bandwidth of the reader). FIGS. 5A-5C illustrate frequency shifting that may be applied to chips to produce the tones illustrated. Note that in the illustrated embodiment the tone duration is equal to one eight of the symbol duration. In other embodiments, different configurations may be used.

In one embodiment, as illustrated in FIG. 1, a first ambient IoT device can be configured with two sampling rates. The first sampling rate can be used by the ambient IoT device to determine the symbol duration, and the second sampling rate can be used by the ambient IoT device to determine the total number of tones/chips/frequency shift/resources within the symbol duration. Additionally, the ambient IoT device can be configured/indicated with a specific pattern for selective transmission on some of the tones/chips/frequency shift/resources within the symbol duration. For instance, in the illustrated embodiment, the first ambient IoT device is configured to backscatter/transmit on a first set of tones 102. The first set of tones 102 include tone 1, tone 2, tone 3, and tone 4 with a first frequency shift applied.

A second ambient IoT device can be configured with the same two sampling rates as the first device. Additionally, the second ambient IoT device may be configured/indicated with a specific pattern for selective transmission on some of the tones/chips/frequency shift/resources within the symbol duration. The tones/chips/frequency shift/resources configured/indicated for the second ambient IoT device can be orthogonal to the tones/chips/frequency shift/resources configured/indicated for the first ambient IoT device. For instance, in the illustrated embodiment, the second ambient IoT device is configured to backscatter/transmit on a second set of tones 104. The second set of tones 104 include tone 5, tone 6, tone 7, and tone 8 with a second frequency shift applied.

In some embodiments, the network (e.g., reader or base station) may provide an indication or configuration of the tones/chips/frequency shift/resources that the ambient IoT device should use for multiple access. According to at least one embodiment, a network may configure an ambient IoT device with one or more different settings related to the tones/chips/frequency shift/resources to use for multiple access. In some embodiments, the network can configure an ambient IoT device with an effective code rate relative to number of tones/chips/frequency shift/resources within the symbol duration and/or a starting offset relative to the first tone/chip/frequency resource within the symbol duration. Further, the network may configure the ambient IoT device with a gap between two tones/chips/frequency shift/resources within the symbol duration.

For example, the network may use the effective code rate, starting offset, and/or gap to indicate the number of tones/chips/frequency shift/resources within a symbol duration. The starting offset may be used to indicate when in the symbol the ambient IoT is to use the tones/chips/frequency. For instance, the network may indicate the offset in terms of absolute time duration or as a factor of the number of chips/tones/frequency shift/resources.

In at least one embodiment, the effective code rate may not be explicitly indicated by the network. Instead, the ambient IoT device can determine the effective code rate to be the same as the sampling rate of the symbol duration.

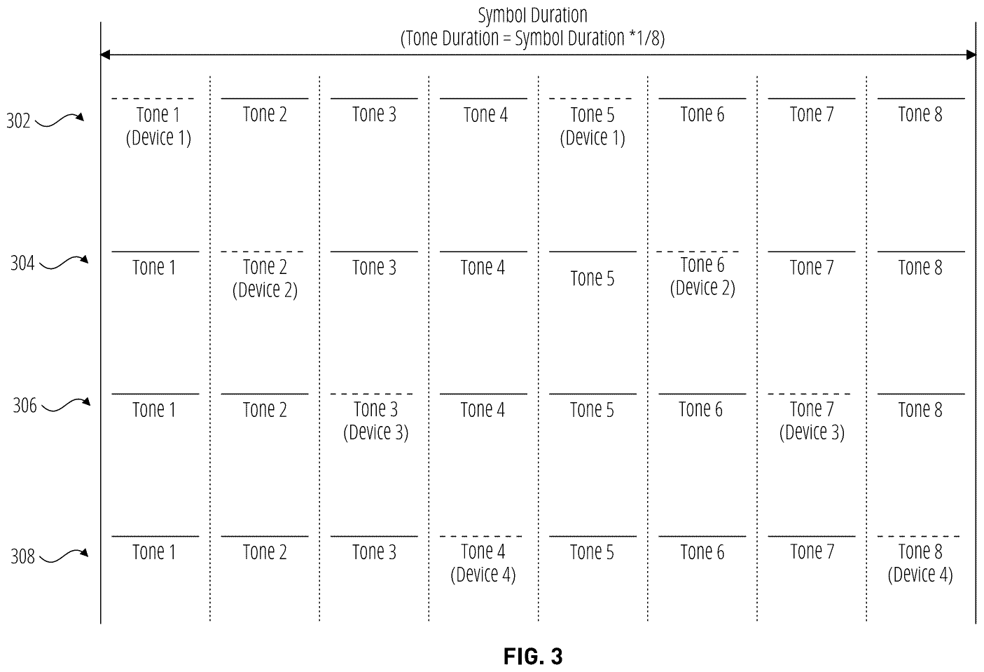

In some embodiments, if the gap between the two tones/chips/frequency shift/resources is not explicitly indicated, the UE can be determined that all the required tones/chips/frequency shift/resources within the symbol duration are contiguous. For instance, in some embodiments if the gap is not explicitly indicated, the ambient IoT device may determine that are tones/chips/frequency shift/resources contiguous and the network is not doing any interleaving of tones/chips/frequency shift/resources across devices. For example, FIG. 1 illustrates a non-inter leaved embodiment where the first device and the second device are provided continuous tones/chips/frequency shift/resources. FIG. 2 and FIG. 3 illustrate examples of non-contiguous tones/chips/frequency shift/resources.

In some embodiments, if the starting offset is not explicitly indicated, then the first tone within the symbol duration can be determined to be the starting tone for the UE. In some embodiments, a pre-configuration can be provided/known to the ambient IoT device, wherein the pre-configuration may include multiple indices with a tone pattern for UEs and the signaling from network may indicate one from the list of indices.

FIG. 2 and FIG. 3 show examples of the use of non-contiguous tones that may be used for multiple access in accordance with one or more embodiments of the present disclosure. Specifically, FIG. 2 illustrates an example where two devices are configured to transmit/backscatter on four tones/chips/frequency shift/resources with a gap that divides the four tones/chips/frequency shift/resources in accordance with some embodiments. As shown, the two devices may be configured to transmit/backscatter on two contiguous tones/chips/frequency shift/resources and then wait for a gap of two tones/chips/frequency shift/resources before transmitting/backscattering for another two tones/chips/frequency shift/resources.

As shown, the first device may be configured to transmit/backscatter on a first set of tones/chips/frequency shift/resources 202 and a second set of tones/chips/frequency shift/resources 204 with a gap 206 between. For instance, the network may configure the first device to have an effective code rate that results in eight tones/chips/frequency shift/resources per symbol, a starting offset of zero (e.g., begin transmission at symbol beginning), and a gap 206 of two tones after the first set of tones/chips/frequency shift/resources 202. The first device may be configured to transmit/backscatter using a first frequency shift.

A second device to transmit/backscatter on a third set of tones/chips/frequency shift/resources 208 and a fourth set of tones/chips/frequency shift/resources 210 with a gap between. For instance, the network may configure the second device to have an effective code rate that results in eight tones/chips/frequency shift/resources per symbol, a starting offset of two tones, and a gap of two tones after the third set of tones/chips/frequency shift/resources 208. The second device may be configured to transmit/backscatter using a second frequency shift. As shown, the second device may transmit on the third set of tones/chips/frequency shift/resources 208 on the second frequency shift during the gap 206 of the first device. Thus, the transmissions/backscattering of different devices may be interleaved.

FIG. 3 illustrates an example where for devices are configured to transmit/backscatter with non-contiguous tones/chips/frequency shift/resources in accordance with some embodiments. As shown, the four devices may be configured to transmit on orthogonal tones/chips/frequency shift/resources within the symbol. For example, the first device tones 302 may include tone 1 and tone 5, the second device tones 304 may include tone 2 and tone 6, the third device tones 306 may include tone 3 and tone 7, and the fourth device tones 308 may include tone 4 and tone 8. The network may configure the effective code rate, the starting offset, and the gap for each ambient IoT device. This may allow each of the four devices to use the same symbol thereby increasing capacity.

In some embodiments, the network may configure/indicate a hopping pattern for ambient IoT devices for transmitting/backscattering the uplink. The hopping pattern indicated different tones/chips/frequency shift/resources for transmission/backscattering after a period of fixed number of tones may indicate a hopping pattern and corresponding period of hopping.

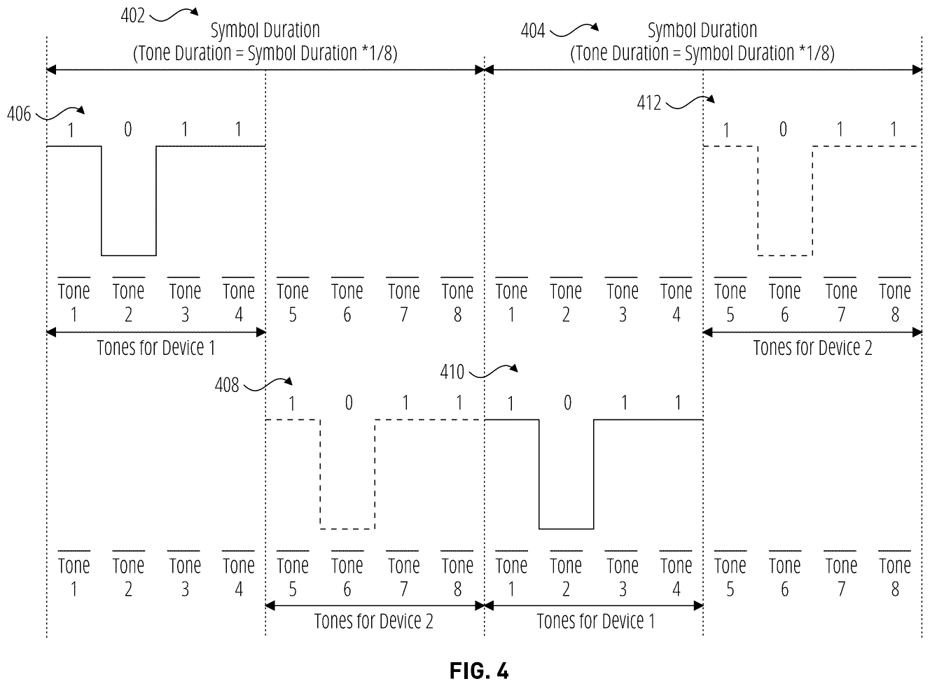

FIG. 4 shows an example of tone hopping for multiple access in accordance with one or more examples of the present disclosure. In at least one embodiment, a hopping pattern can be configured/indicated from the network to ambient IoT device for transmitting/backscattering UL, wherein the hopping pattern can indicate different tones and frequencies for transmission/backscattering after a period of fixed number of tones.

In at least one embodiment, as illustrated in FIG. 4, a first ambient IoT device can be configured with two sampling rates where the first sampling rate can be used to determine the symbol duration, and the second sampling rate can be used to determine the total number of tones/chips/frequency shift/resources within the symbol duration. In the illustrated embodiment, there are eight tones/chips/frequency shift/resources during the symbol. Additionally, the network may configure/indicate to the first ambient IoT device a hopping pattern and corresponding period of hopping.

A second ambient IoT device can be configured with the same two sampling rates as the first device. Additionally, the second ambient IoT device can be configured/indicated with a hopping pattern that can be orthogonal to the hopping pattern indicated to first ambient IoT device and corresponding period of hopping that may be same as indicated for first ambient IoT device.

For example, in the illustrated embodiment, the first device is configured with a first set of tones/chips/frequency shift/resources 406 during a first symbol 402. The second device is configured with a second set of tones/chips/frequency shift/resources 408 during the first symbol 402. The first set of tones/chips/frequency shift/resources 406 and the second set of tones/chips/frequency shift/resources 408 being orthogonal to one another. The first set of tones/chips/frequency shift/resources 406 corresponding to a first frequency shift and the second set of tones/chips/frequency shift/resources 408 corresponding to a second frequency shift.

In the illustrated embodiment, the first and second device are configured with frequency hopping to alternate to opposite tones in the second symbol 404. For instance, in the second symbol 404 the first device may use a third set of tones/chips/frequency shift/resources 410, and the second device may use a fourth set of tones/chips/frequency shift/resources 412. The devices may use a different frequency shift on the second symbol 404 then what they used on the first symbol.

In at least one embodiment, the network may configure ambient IoT device with a first starting offset relative to the first tone/chip/frequency resource within the first hop period and a second starting offset relative to the first tone/chip/frequency resource within the second hop period.

In some embodiments, the hopping pattern is not explicitly indicated and the tones/chips/frequency shift/resources for the second hop are determined in an implicit manner. In at least one embodiment, if the first hop has effective code rate as half of the symbol rate, then the second hop can occupy all the tones/chips/frequency shift/resources that are not used during the first hop. In some embodiments, the tones/chips/frequency shift/resources in the second hop can be shifted in a cyclic manner such that the shift is determined by the next empty tone in the first hop.

In some embodiments, a pre-configuration can be provided/known to ambient IoT device, wherein the pre-configuration may include multiple indices with a tone/chip/frequency resource hopping pattern for UEs. Additionally, the signaling from the network may indicate one index from the list of indices. Thus, the hopping patterns may be pre-configured and the network may dynamically or semi-statically indicate one of the pre-configured options by indicating an index value.

FIG. 5A through FIG. 5C illustrate example device to reader (D2R) Bandwidths (e.g., uplink bandwidths). These bandwidths may be used to apply a frequency shift to the transmission bandwidth for the device's transmission/backscatter to the reader. The illustrations provide bandwidths for the D2R transmissions. A transmission bandwidth (B_{tx,D2R}) may be the frequency shift/resources scheduled by a reader for a D2R transmission from one device. The occupied bandwidth (B_{occ,D2R}) may be the transmission bandwidth plus the potential associated intra ambient IoT guard-bands totaling B_{guard,D2R}. Note that this guard band is not for coexistence with NR/LTE. In some embodiments, B_{occ,D2R} is greater than or equal to B_{tx,D2R}.

For B_{tx,D2R} of the D2R transmissions associated with one/each single-tone of a carrier wave, the following figures depict small frequency-shift. In FIG. 5A and FIG. 5C, a Manchester line code with option 1, and if no D2R line-code is used (i.e., by using a square-wave corresponding to the small frequency-shift). In FIG. 5B, a Manchester line code with option 2, and by Miller line code is used.

The parameters in FIGS. 5A-5C represent the following. F_{c} is the carrier-wave frequency, at least when externally generated. FSₓ depict examples of amount of small frequency shift. For 2SB transmission, both +FSₓ and −FSₓ parts are included in FIG. 5A and FIG. 5B. For 1SB transmission, one of the upper part or lower part applies, as appropriate, in FIG. 5C.

FIG. 5A illustrates an example embodiment 502 where B_{tx,D2R} and B_{occ,D2R} for 2SB transmission of Manchester line code with option 1, and if no D2R line code is used (i.e., by using a square-wave corresponding to the small frequency-shift). FIG. 5B illustrates an example embodiment 504 where B_{tx,D2R} and B_{occ,D2R} for 2SB transmission of Manchester line code with option 2, and by Miller line code is used. FIG. 5C illustrates an example embodiment 506 where B_{tx,D2R} and B_{occ,D2R} for 1SB transmission of Manchester line code with option 1, and if no D2R line code is used (i.e., by using a square-wave corresponding to the small frequency shift).

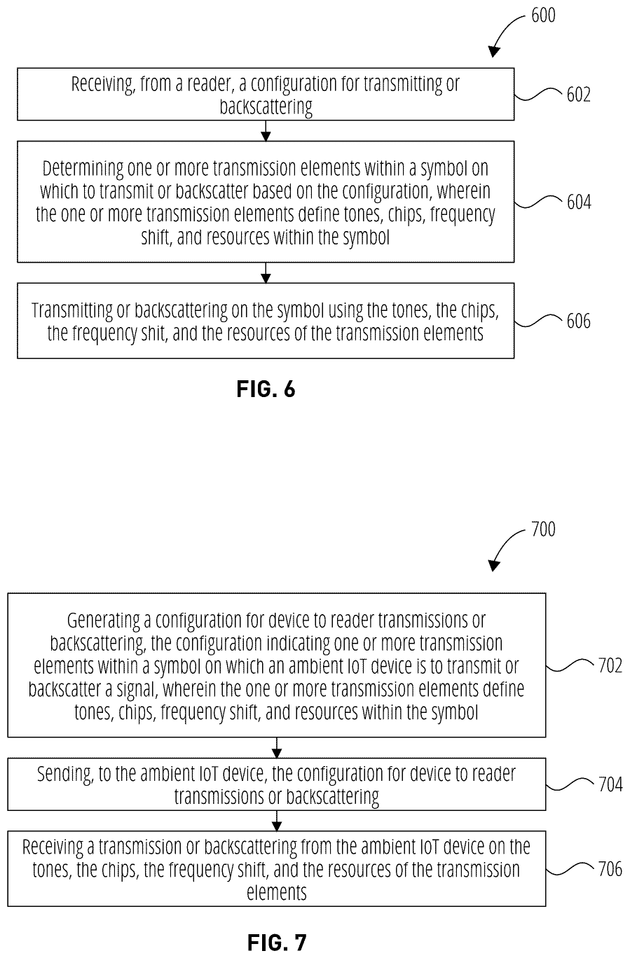

FIG. 6 illustrates a method 600 for an ambient IoT device, according to embodiments herein. The illustrated method 600 incudes receiving 602, from a reader, a configuration for transmitting or backscattering. The method 600 further includes determining 604 one or more transmission elements within a symbol on which to transmit or backscatter based on the configuration, wherein the one or more transmission elements define at least one of tones, chips, frequency shift or resources within the symbol. The method 600 further includes transmitting or backscattering 606 on the symbol using the tones, the chips, the frequency shift, and/or the resources of the transmission elements.

In some embodiments of the method 600, the configuration comprises a first sampling rate and a second sampling rate, wherein the first sampling rate is used to determine a symbol duration and the second sampling rate is used to determine a total number of transmission elements within the symbol duration.

In some embodiments of the method 600, transmitting or backscattering is performed during multiple segments of the symbol indicated in the configuration and by applying a frequency shift within the symbol duration.

In some embodiments of the method 600, multiple different ambient IoT devices are configured with different tones, different chips, different frequency shift, and/or different resources within the symbol that are orthogonal.

In some embodiments of the method 600, the configuration further comprises a specific pattern for transmitting or backscattering on the tones, the chips, the frequency shift, and/or resources within the symbol duration.

In some embodiments of the method 600, the configuration comprises an effective code rate relative to a number of the transmission elements within a symbol duration, a starting offset relative to a first transmission element within the symbol duration, and a gap between two transmission elements within the symbol duration.

In some embodiments of the method 600, the configuration comprises a hopping pattern, wherein the hopping pattern indicates different tones, different chips, different frequency shift, and/or different resources for transmission or backscattering after a period of fixed number of transmission elements.

FIG. 7 illustrates a method 700 for a base station, according to embodiments herein. The illustrated method 700 includes generating 702 a configuration for device to reader transmissions or backscattering, the configuration indicating one or more transmission elements within a symbol on which an ambient IoT device is to transmit or backscatter a signal, wherein the one or more transmission elements define at least one of tones, chips, frequency shift, or resources within the symbol. The method 700 further includes sending 704, to the ambient IoT device, the configuration for device to reader transmissions or backscattering. The method 700 further includes receiving 706 a transmission or backscattering from the ambient IoT device on the tones, the chips, the frequency shift, and/or the resources of the transmission elements.

In some embodiments of the method 700, the configuration comprises a first sampling rate and a second sampling rate, wherein the first sampling rate is used to determine a symbol duration and the second sampling rate is used to determine a total number of transmission elements within the symbol duration.

In some embodiments of the method 700, the transmission or backscattering is sent during multiple segments of the symbol indicated in the configuration and with a frequency shift applied.

In some embodiments of the method 700, multiple different ambient IoT devices are configured with different tones, different chips, different frequency shift, and/or different resources within the symbol that are orthogonal.

In some embodiments of the method 700, the configuration further comprises a specific pattern for transmitting or backscattering on the tones, the chips, the frequency shift, and/or the resources within the symbol duration.

In some embodiments of the method 700, the configuration comprises an effective code rate relative to a number of the transmission elements within a symbol duration, a starting offset relative to a first transmission element within the symbol duration, and a gap between two transmission elements within the symbol duration.

In some embodiments of the method 700, the configuration comprises a hopping pattern, wherein the hopping pattern indicates different tones, different chips, different frequency shift, and/or resources for transmission or backscattering after a period of fixed number of transmission elements.

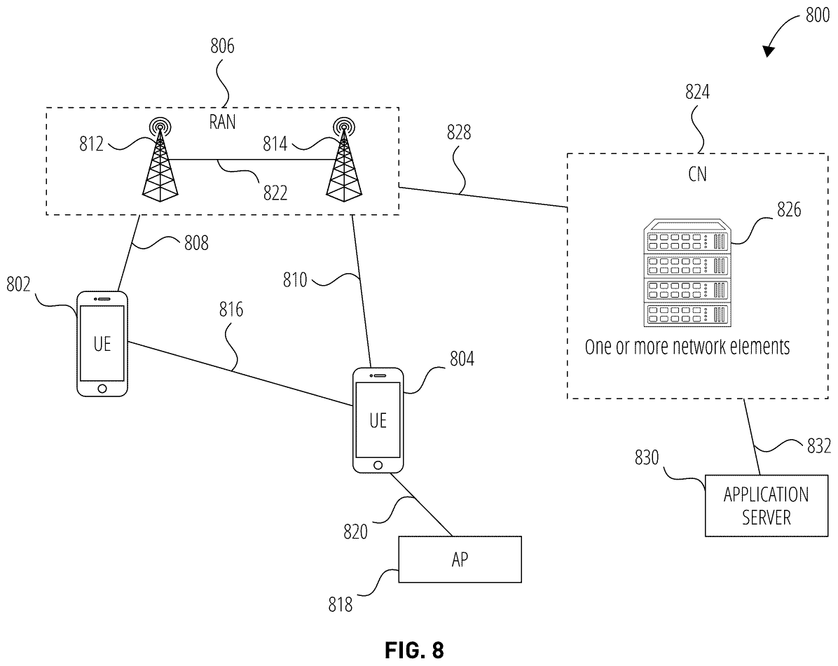

FIG. 8 illustrates an example architecture of a wireless communication system 800, according to embodiments disclosed herein. The following description is provided for an example wireless communication system 800 that operates in conjunction with the LTE system standards and/or 5G or NR system standards as provided by 3GPP technical specifications.

As shown by FIG. 8, the wireless communication system 800 includes UE 802 and UE 804 (although any number of UEs may be used). In this example, the UE 802 and the UE 804 are illustrated as smartphones (e.g., handheld touchscreen mobile computing devices connectable to one or more cellular networks), but may also comprise any mobile or non-mobile computing device configured for wireless communication.

The UE 802 and UE 804 may be configured to communicatively couple with a RAN 806. In embodiments, the RAN 806 may be NG-RAN, E-UTRAN, etc. The UE 802 and UE 804 utilize connections (or channels) (shown as connection 808 and connection 810, respectively) with the RAN 806, each of which comprises a physical communications interface. The RAN 806 can include one or more base stations (such as base station 812 and base station 814) that enable the connection 808 and connection 810.

In this example, the connection 808 and connection 810 are air interfaces to enable such communicative coupling, and may be consistent with RAT(s) used by the RAN 806, such as, for example, an LTE and/or NR.

In some embodiments, the UE 802 and UE 804 may also directly exchange communication data via a sidelink interface 816. The UE 804 is shown to be configured to access an access point (shown as AP 818) via connection 820. By way of example, the connection 820 can comprise a local wireless connection, such as a connection consistent with any IEEE 802.11 protocol, wherein the AP 818 may comprise a Wi-Fi® router. In this example, the AP 818 may be connected to another network (for example, the Internet) without going through a CN 824.

In embodiments, the UE 802 and UE 804 can be configured to communicate using orthogonal frequency division multiplexing (OFDM) communication signals with each other or with the base station 812 and/or the base station 814 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 812 or base station 814 may be implemented as one or more software entities running on server computers as part of a virtual network. In addition, or in other embodiments, the base station 812 or base station 814 may be configured to communicate with one another via interface 822. In embodiments where the wireless communication system 800 is an LTE system (e.g., when the CN 824 is an EPC), the interface 822 may be an X2 interface. The X2 interface may be defined between two or more base stations (e.g., two or more eNBs and the like) that connect to an EPC, and/or between two eNBs connecting to the EPC. In embodiments where the wireless communication system 800 is an NR system (e.g., when CN 824 is a 5GC), the interface 822 may be an Xn interface. The Xn interface is defined between two or more base stations (e.g., two or more gNBs and the like) that connect to 5GC, between a base station 812 (e.g., a gNB) connecting to 5GC and an eNB, and/or between two eNBs connecting to 5GC (e.g., CN 824).

The RAN 806 is shown to be communicatively coupled to the CN 824. The CN 824 may comprise one or more network elements 826, which are configured to offer various data and telecommunications services to customers/subscribers (e.g., users of UE 802 and UE 804) who are connected to the CN 824 via the RAN 806. The components of the CN 824 may be implemented in one physical device or separate physical devices including components to read and execute instructions from a machine-readable or computer-readable medium (e.g., a non-transitory machine-readable storage medium).

In embodiments, the CN 824 may be an EPC, and the RAN 806 may be connected with the CN 824 via an S1 interface 828. In embodiments, the S1 interface 828 may be split into two parts, an S1 user plane (S1-U) interface, which carries traffic data between the base station 812 or base station 814 and a serving gateway (S-GW), and the S1-MME interface, which is a signaling interface between the base station 812 or base station 814 and mobility management entities (MMEs).

In embodiments, the CN 824 may be a 5GC, and the RAN 806 may be connected with the CN 824 via an NG interface 828. In embodiments, the NG interface 828 may be split into two parts, an NG user plane (NG-U) interface, which carries traffic data between the base station 812 or base station 814 and a user plane function (UPF), and the S1 control plane (NG-C) interface, which is a signaling interface between the base station 812 or base station 814 and access and mobility management functions (AMFs).

Generally, an application server 830 may be an element offering applications that use internet protocol (IP) bearer resources with the CN 824 (e.g., packet switched data services). The application server 830 can also be configured to support one or more communication services (e.g., VoIP sessions, group communication sessions, etc.) for the UE 802 and UE 804 via the CN 824. The application server 830 may communicate with the CN 824 through an IP communications interface 832.

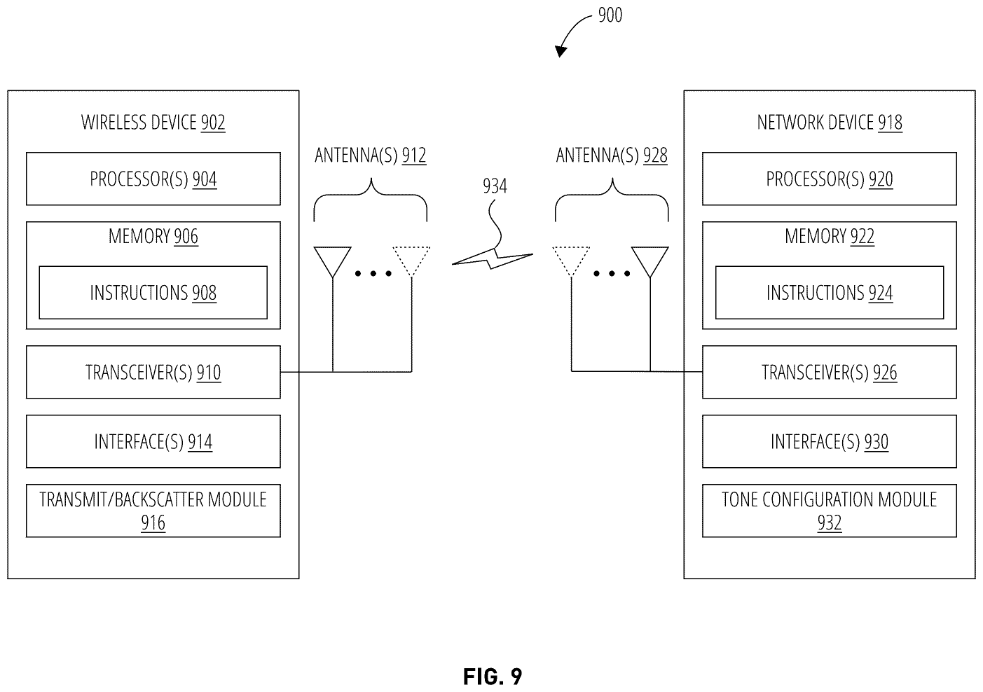

FIG. 9 illustrates a system 900 for performing signaling 934 between a wireless device 902 and a network device 918, according to embodiments disclosed herein. The system 900 may be a portion of a wireless communications system as herein described. The wireless device 902 may be, for example, an ambient IoT device (e.g., a UE) of a wireless communication system. The network device 918 may be, for example, a base station (e.g., an eNB or a gNB) of a wireless communication system.

The wireless device 902 may include one or more processor(s) 904. The processor(s) 904 may execute instructions such that various operations of the wireless device 902 are performed, as described herein. The processor(s) 904 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 902 may include a memory 906. The memory 906 may be a non-transitory computer-readable storage medium that stores instructions 908 (which may include, for example, the instructions being executed by the processor(s) 904). The instructions 908 may also be referred to as program code or a computer program. The memory 906 may also store data used by, and results computed by, the processor(s) 904.

The wireless device 902 may include one or more transceiver(s) 910 that may include radio frequency (RF) transmitter circuitry and/or receiver circuitry that use the antenna(s) 912 of the wireless device 902 to facilitate signaling (e.g., the signaling 934) to and/or from the wireless device 902 with other devices (e.g., the network device 918) according to corresponding RATs.

The wireless device 902 may include one or more antenna(s) 912 (e.g., one, two, four, or more). For embodiments with multiple antenna(s) 912, the wireless device 902 may leverage the spatial diversity of such multiple antenna(s) 912 to send and/or receive multiple different data streams on the same time and frequency shift/resources. This behavior may be referred to as, for example, multiple input multiple output (MIMO) behavior (referring to the multiple antennas used at each of a transmitting device and a receiving device that enable this aspect). MIMO transmissions by the wireless device 902 may be accomplished according to precoding (or digital beamforming) that is applied at the wireless device 902 that multiplexes the data streams across the antenna(s) 912 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 902 may implement analog beamforming techniques, whereby phases of the signals sent by the antenna(s) 912 are relatively adjusted such that the (joint) transmission of the antenna(s) 912 can be directed (this is sometimes referred to as beam steering).

The wireless device 902 may include one or more interface(s) 914. The interface(s) 914 may be used to provide input to or output from the wireless device 902. For example, a wireless device 902 that is a UE may include interface(s) 914 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 910/antenna(s) 912 already described) that allow for communication between the UE and other devices and may operate according to known protocols (e.g., Wi-Fi®, Bluetooth® and the like).

The wireless device 902 may include a transmit/backscatter module 916. The transmit/backscatter module 916 may be implemented via hardware, software, or combinations thereof. For example, the transmit/backscatter module 916 may be implemented as a processor, circuit, and/or instructions 908 stored in the memory 906 and executed by the processor(s) 904. In some examples, the transmit/backscatter module 916 may be integrated within the processor(s) 904 and/or the transceiver(s) 910. For example, the transmit/backscatter module 916 may be implemented by a combination of software components (e.g., executed by a DSP or a general processor) and hardware components (e.g., logic gates and circuitry) within the processor(s) 904 or the transceiver(s) 910.

The transmit/backscatter module 916 may be used for various aspects of the present disclosure, for example, aspects of FIGS. 1-6.

The network device 918 may include one or more processor(s) 920. The processor(s) 920 may execute instructions such that various operations of the network device 918 are performed, as described herein. The processor(s) 920 may include one or more baseband processors implemented using, for example, a CPU, a DSP, an ASIC, a controller, an FPGA device, another hardware device, a firmware device, or any combination thereof configured to perform the operations described herein.

The network device 918 may include a memory 922. The memory 922 may be a non-transitory computer-readable storage medium that stores instructions 924 (which may include, for example, the instructions being executed by the processor(s) 920). The instructions 924 may also be referred to as program code or a computer program. The memory 922 may also store data used by, and results computed by, the processor(s) 920.

The network device 918 may include one or more transceiver(s) 926 that may include RF transmitter circuitry and/or receiver circuitry that use the antenna(s) 928 of the network device 918 to facilitate signaling (e.g., the signaling 934) to and/or from the network device 918 with other devices (e.g., the wireless device 902) according to corresponding RATs.

The network device 918 may include one or more antenna(s) 928 (e.g., one, two, four, or more). In embodiments having multiple antenna(s) 928, the network device 918 may perform MIMO, digital beamforming, analog beamforming, beam steering, etc., as has been described.

The network device 918 may include one or more interface(s) 930. The interface(s) 930 may be used to provide input to or output from the network device 918. For example, a network device 918 that is a base station may include interface(s) 930 made up of transmitters, receivers, and other circuitry (e.g., other than the transceiver(s) 926/antenna(s) 928 already described) that enables the base station to communicate with other equipment in a core network, and/or that enables the base station to communicate with external networks, computers, databases, and the like for purposes of operations, administration, and maintenance of the base station or other equipment operably connected thereto.

The network device 918 may include a tone configuration module 932. The tone configuration module 932 may be implemented via hardware, software, or combinations thereof. For example, the tone configuration module 932 may be implemented as a processor, circuit, and/or instructions 924 stored in the memory 922 and executed by the processor(s) 920. In some examples, the tone configuration module 932 may be integrated within the processor(s) 920 and/or the transceiver(s) 926. For example, the tone configuration module 932 may be implemented by a combination of software components (e.g., executed by a DSP or a general processor) and hardware components (e.g., logic gates and circuitry) within the processor(s) 920 or the transceiver(s) 926.

The tone configuration module 932 may be used for various aspects of the present disclosure, for example, aspects of FIGS. 1-5 and 7.

Embodiments contemplated herein include an apparatus comprising means to perform one or more elements of the method 600. This apparatus may be, for example, an apparatus of a UE (such as a wireless device 902 that is a UE, as described herein).

Embodiments contemplated herein include one or more non-transitory computer-readable media comprising instructions to cause an electronic device, upon execution of the instructions by one or more processors of the electronic device, to perform one or more elements of the method 600. This non-transitory computer-readable media may be, for example, a memory of a UE (such as a memory 906 of a wireless device 902 that is an ambient IoT device, as described herein).

Embodiments contemplated herein include an apparatus comprising logic, modules, or circuitry to perform one or more elements of the method 600. This apparatus may be, for example, an apparatus of a UE (such as a wireless device 902 that is a UE, as described herein).

Embodiments contemplated herein include an apparatus comprising: one or more processors and one or more computer-readable media comprising instructions that, when executed by the one or more processors, cause the one or more processors to perform one or more elements of the method 600. This apparatus may be, for example, an apparatus of a UE (such as a wireless device 902 that is an ambient IoT device, as described herein).

Embodiments contemplated herein include a signal as described in or related to one or more elements of the method 600.

Embodiments contemplated herein include a computer program or computer program product comprising instructions, wherein execution of the program by a processor is to cause the processor to carry out one or more elements of the method 600. The processor may be a processor of a UE (such as a processor(s) 904 of a wireless device 902 that is an ambient IoT device, as described herein). These instructions may be, for example, located in the processor and/or on a memory of the UE (such as a memory 906 of a wireless device 902 that is an ambient IoT device, as described herein).

Embodiments contemplated herein include an apparatus comprising means to perform one or more elements of the method 700. This apparatus may be, for example, an apparatus of a base station (such as a network device 918 that is a base station, as described herein).

Embodiments contemplated herein include one or more non-transitory computer-readable media comprising instructions to cause an electronic device, upon execution of the instructions by one or more processors of the electronic device, to perform one or more elements of the method 700. This non-transitory computer-readable media may be, for example, a memory of a base station (such as a memory 922 of a network device 918 that is a base station, as described herein).

Embodiments contemplated herein include an apparatus comprising logic, modules, or circuitry to perform one or more elements of the method 700. This apparatus may be, for example, an apparatus of a base station (such as a network device 918 that is a base station, as described herein).

Embodiments contemplated herein include an apparatus comprising: one or more processors and one or more computer-readable media comprising instructions that, when executed by the one or more processors, cause the one or more processors to perform one or more elements of the method 700. This apparatus may be, for example, an apparatus of a base station (such as a network device 918 that is a base station, as described herein).

Embodiments contemplated herein include a signal as described in or related to one or more elements of the method 700.

Embodiments contemplated herein include a computer program or computer program product comprising instructions, wherein execution of the program by a processing element is to cause the processing element to carry out one or more elements of the method 700. The processor may be a processor of a base station (such as a processor(s) 920 of a network device 918 that is a base station, as described herein). These instructions may be, for example, located in the processor and/or on a memory of the base station (such as a memory 922 of a network device 918 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for an ambient Internet of Things (IoT) device, the method comprising:
receiving, from a reader, a configuration for transmitting or backscattering;
determining one or more transmission elements within a symbol on which to transmit or backscatter based on the configuration, wherein the one or more transmission elements define at least one of tones, chips, frequency shift, or resources within the symbol; and
transmitting or backscattering on the symbol using the tones, the chips, the frequency shift, or the resources of the transmission elements.

2. The method of claim 1, wherein the configuration comprises a first sampling rate and a second sampling rate, wherein the first sampling rate is used to determine a symbol duration and the second sampling rate is used to determine a total number of transmission elements within the symbol duration.

3. The method of claim 1, wherein transmitting or backscattering is performed during multiple segments of the symbol indicated in the configuration and by applying a frequency shift within a symbol duration.

4. The method of claim 1, wherein multiple different ambient IoT devices are configured with different tones, different chips, and different frequency shift/resources within the symbol that are orthogonal.

5. The method of claim 1, wherein the configuration further comprises a specific pattern for transmitting or backscattering on the tones, the chips, and the frequency shift/resources within a symbol duration.

6. The method of claim 1, wherein the configuration comprises an effective code rate relative to a number of the transmission elements within a symbol duration, a starting offset relative to a first transmission element within the symbol duration, and a gap between two transmission elements within the symbol duration.

7. The method of claim 1, wherein the configuration comprises a hopping pattern, wherein the hopping pattern indicates different tones, different chips, and different frequency shift/resources for transmission or backscattering after a period of fixed number of transmission elements.

8. A method for a base station, the method comprising:
generating a configuration for device to reader transmissions or backscattering, the configuration indicating one or more transmission elements within a symbol on which an ambient Internet of Things (IoT) device is to transmit or backscatter a signal, wherein the one or more transmission elements define at least one of tones, chips, and frequency shift, or resources within the symbol;
sending, to the ambient IoT device, the configuration for device to reader transmissions or backscattering; and
receiving a transmission or backscattering from the ambient IoT device on the tones, the chips, and the frequency shift/resources of the transmission elements.

9. The method of claim 8, wherein the configuration comprises a first sampling rate and a second sampling rate, wherein the first sampling rate is used to determine a symbol duration and the second sampling rate is used to determine a total number of transmission elements within the symbol duration.

10. The method of claim 8, wherein the transmission or backscattering is sent during multiple segments of the symbol indicated in the configuration and with a frequency shift applied.

11. The method of claim 8, wherein multiple different ambient IoT devices are configured with different tones, different chips, and different frequency shift/resources within the symbol that are orthogonal.

12. The method of claim 8, wherein the configuration further comprises a specific pattern for transmitting or backscattering on the tones, the chips, and the frequency shift/resources within a symbol duration.

13. The method of claim 8, wherein the configuration comprises an effective code rate relative to a number of the transmission elements within a symbol duration, a starting offset relative to a first transmission element within the symbol duration, and a gap between two transmission elements within the symbol duration.

14. The method of claim 8, wherein the configuration comprises a hopping pattern, wherein the hopping pattern indicates different tones, different chips, and different frequency shift/resources for transmission or backscattering after a period of fixed number of transmission elements.

15. An ambient Internet of Things (IoT) device apparatus comprising:
a processor; and
a memory storing instructions that, when executed by the processor, configure the apparatus to:
receive, from a reader, a configuration for transmitting or backscattering;
determine one or more transmission elements within a symbol on which to transmit or backscatter based on the configuration, wherein the one or more transmission elements define at least one of tones, chips, frequency shift, or resources within the symbol; and
transmit or backscatter on the symbol using the tones, the chips, and the frequency shift/resources of the transmission elements.

16. The ambient IoT device apparatus of claim 15, wherein the configuration comprises a first sampling rate and a second sampling rate, wherein the first sampling rate is used to determine a symbol duration and the second sampling rate is used to determine a total number of transmission elements within the symbol duration.

17. The ambient IoT device apparatus of claim 15, wherein transmitting or backscatter is performed during multiple segments of the symbol indicated in the configuration and by applying a frequency shift.

18. The ambient IoT device apparatus of claim 15, wherein multiple different ambient IoT devices are configured with different tones, different chips, and different frequency shift/resources within the symbol that are orthogonal.

19. The ambient IoT device apparatus of claim 15, wherein the configuration further comprises a specific pattern for transmitting or backscatter on the tones, the chips, and the frequency shift/resources within a symbol duration.

20. The ambient IoT device apparatus of claim 15, wherein the configuration comprises an effective code rate relative to a number of the transmission elements within a symbol duration, a starting offset relative to a first transmission element within the symbol duration, and a gap between two transmission elements within the symbol duration.
